(19) United States
(12) Patent Application Publication
(10) Pub. No.: US 2015/0368851 A1
(43) Pub. Date: Dec. 24, 2015

(54) LAUNDRY DRYING DEVICE

(71) Applicant: Thomas Bickham, Frederiksberg (DK)

(72) Inventor: Thomas Bickham, Frederiksberg (DK)

(21) Appl. No.: 14/311,300

(22) Filed: Jun. 22, 2014

(51) Int. Cl. D06F 55/00; F16B 2/22

(52) U.S. Cl. CPC D06F 55/00; F16B 2/22

(57) ABSTRACT

The aspects of the present disclosure relate to a laundry drying device for clothes lines, laundry racks and the like, that includes an elongated body extending in a longitudinal direction defined by a longitudinal axis X, where the body is configured such that it can surround a clothes line or a bar or line of a drying rack, where the body is a unitary body and where the body is provided with at least one longitudinally extending slit extending from a surface portion of the body and a distance (d) into the body, the slit having a thickness (t), which at least one slit is configured to allow a clothes line or bar to be received in the slit, whereby the device can be hung on the clothes line or bar.

### TECHNICAL FIELD

The aspects of the present disclosure relate to an auxiliary device for clothes lines that can be used to prevent the formation of wrinkles on clothes hung from a clothes line.

### BACKGROUND

When laundry is hung from a clothesline it is often secured to the clothesline by means of clothespins to prevent the laundry from falling off the clothesline. In case of large pieces of textiles, such as bedclothes or tablecloths it may be possible to hang the textile over the clothesline without it being necessary to secure it to the clothesline with clothespins.

Both in the case where the textile is secured to the clothesline by clothespins or simply hung over the clothesline, this will result in the formation of wrinkles or creases in the textile that may necessitate ironing of the textile after drying.

WO 2011/033326 A1 describes an auxiliary device for improving drying time of laundry hung on a clothes line which device comprise an elongated body for example in the form of a cylinder. The elongated body is internally provided with a thin channel through which a clothes line can pass. Access of the clothesline to can in some of the embodiments described in this document be obtained by separating the body in two parts that are afterwards, when the body has been fitted over the clothes line, snapped together and held together by tabs on one of the two body parts coming into engagement with corresponding locking holes in the other body part. This document also describes an alternative embodiment in which the two body parts are connected above the channel to form a single piece after the two body parts are snapped together following the insertion of a clothes line in the channel.

### SUMMARY

The aspects of the present disclosure provide a laundry drying device of a very simple and cheap design that can be secured to clothing lines or drying racks of different dimensions.

The above and other aspects and advantages are obtained with the present disclosure by the provision of a laundry drying device for clothes lines, laundry racks and the like, comprising an elongated body extending in a longitudinal direction defined by a longitudinal axis X, where the body comprises a top surface, side surfaces, end surfaces and bottom surface, where the body is configured such that it can surround a clothes line or a bar or line provided on a drying rack, where the body is a unitary body (i.e. made in one piece), and where the body is provided with at least one longitudinally extending extending from a surface portion of the body and a distance d into the body, the slit having a thickness t, which at least one slit is configured to allow a clothes line 17 or bar 14 to be received in the slit, whereby the device can be hung on the clothes line 17 or bar 14.

According to a preferred embodiment of the present disclosure, the body is made of a resilient material, such as a foam material or a suitable rubber.

According to an embodiment of the present disclosure the shape of the body is cylindrical, but it is understood that bodies of other cross sectional shape can also be used. Some non-limiting example embodiments having other shapes than cylindrical are shown in the detailed description of the present disclosure.

According to an embodiment of the present disclosure, the thickness t is substantially equal to zero (the slit is provided in the body by cutting a very thin slit longitudinally in the body) such that a clothes line or bar in a drying rack can only be inserted into the slit due to the resiliency of the material of the body.

According to an embodiment of the present disclosure, the thickness t is in the range 0 cm to T cm, where T is substantially equal to the thickness or diameter of a typical clothes line or bar in a drying rack.

According to an embodiment of the present disclosure, the bottom surface comprises rounded portions extending longitudinally on either side of said slit for facilitation insertion of a clothes line or bar in a drying rack into the slit.

According to an embodiment of the present disclosure the side surfaces form an angle a between each other. Depending on the dimensions of the device and on the angle a the side surfaces may either meet at an edge, in which case no bottom surface as such is present in the device, or the remaining bottom surface will have reduced lateral extension compared to the other embodiments described in this specification. In the case where the two side surfaces meet at an edge, the slit extends from the edge portion where the side surfaces meet and into the body of the device.

According to an embodiment of the present disclosure, there is provided a laundry drying device for clothes lines, laundry racks and the like comprising an elongated body 13 extending in a longitudinal direction defined by a longitudinal axis X, where the body is configured such that it can be supported by one or more clothes lines or bars in a laundry rack, and where the body is a unitary body (i.e. formed as one piece of material) and where the body is provided with at least one longitudinally extending radial slit extending a distance into the body, which at least one slit is configured to allow a clothes line or laundry rack bar to be received in the slit, whereby the laundry drying device becomes releasably fixed to one or more clothes lines or one or more bars of a laundry rack.

According to an embodiment of the present disclosure that is particularly suitable for application with a drying rack, the body comprises an upper surface, side surfaces, a bottom surface and end surfaces, where the upper surface is upwardly curved and wherein the bottom face is provided with at least two slits extending from the bottom face into the interior of the body and where the distance between adjacent slits is configured to correspond substantially with the distance between bars of a laundry rack.

Suitable materials for the laundry drying device according to the present disclosure are foamed plastic material or rubber, but it is emphasized that other materials having the required resiliency could also be used.

It is furthermore noted, that in embodiments that are provided with one or more slits of a finite thickness, for instance substantially corresponding to the diameter of an ordinary clothes line, the material of the body need not be resilient, as the slits may be able to receive the clothes line even if the thickness of the slit is slightly less than the diameter of the clothes line, due to resiliency of the clothes line.

Various cross sectional shapes of the body of the laundry drying device of the present disclosure can be envisaged, and non-limiting examples hereof are given in the detailed description. Also the dimensions of the body can vary in different embodiments of the present disclosure.

With the very simple configuration of the laundry drying device according to the present disclosure, this can for instance be manufactured in certain standard lengths and the user can easily cut it down to any specific length he may require.

Although the laundry drying device according to the present disclosure is primarily described herein with application to a clothes line, this does not constitute a limitation of aspects of the claimed subject matter. Thus an example embodiment of a laundry drying device according to the present disclosure is described in detail in the detailed description of the present disclosure, which embodiment is suitable for application on an ordinary drying rack.

### BRIEF DESCRIPTION OF THE DRAWINGS

The aspects of the present disclosure will be better understood with reference to the following detailed description of embodiments hereof in conjunction with the figures of the drawing, in which

FIG. 1 shows a schematic perspective view of a first embodiment of the laundry drying device according to as aspect of the present disclosure;

FIG. 2 shows a schematic perspective view of a second embodiment of the laundry drying device according to an aspect of the present disclosure;

FIG. 3 shows a schematic perspective view of a third embodiment of the laundry drying device according to an aspect of the present disclosure;

FIG. 4 shows a schematic cross section through a fourth embodiment of the laundry drying device according to an aspect of the present disclosure;

FIG. 5 shows a schematic perspective view of a fifth embodiment of the laundry drying device according to an aspect of the present disclosure specifically designed for application together with a drying rack; and

FIGS. 6a to 6e show examples of the cross sectional shape of the laundry device according to different embodiments of the aspects of the present disclosure.

### DETAILED DESCRIPTION OF THE DISCLOSURE

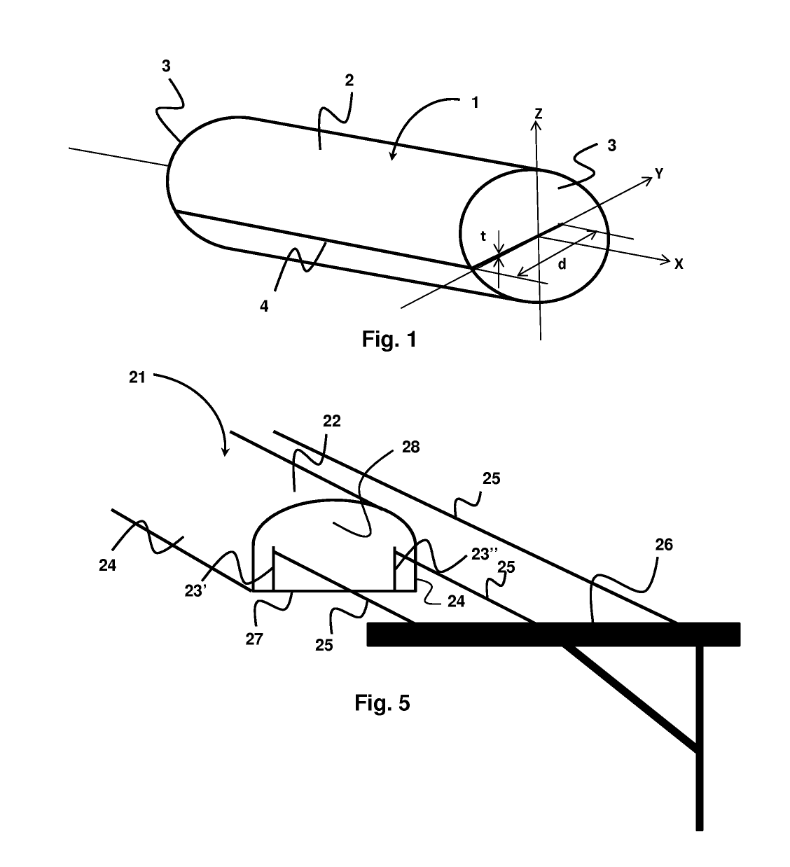

Referring to FIG. 1 there is shown a first embodiment of the laundry drying device according to an aspect of the present disclosure. This embodiment as well as other embodiments to be described below, are geometrically characterized with reference to the Cartesian coordinate system shown in the figure.

The first embodiment of the laundry drying device comprises a cylindrical body 1 comprising an outer circumferential surface 2 and end surfaces 3. In FIG. 1, the longitudinal axis of the cylindrical body coincides with the X-axis of the shown coordinate system.

Radially, and along the entire longitudinal extension of the body, there is provided a slit 4. In the shown embodiment, the slit 4 extends radially from the longitudinal axis of the cylinder and to the circumferential surface 2. This is, however, only a non-limiting example; the slit may alternatively extends radially for a shorter or longer distance than from the circumferential surface to the X-axis.

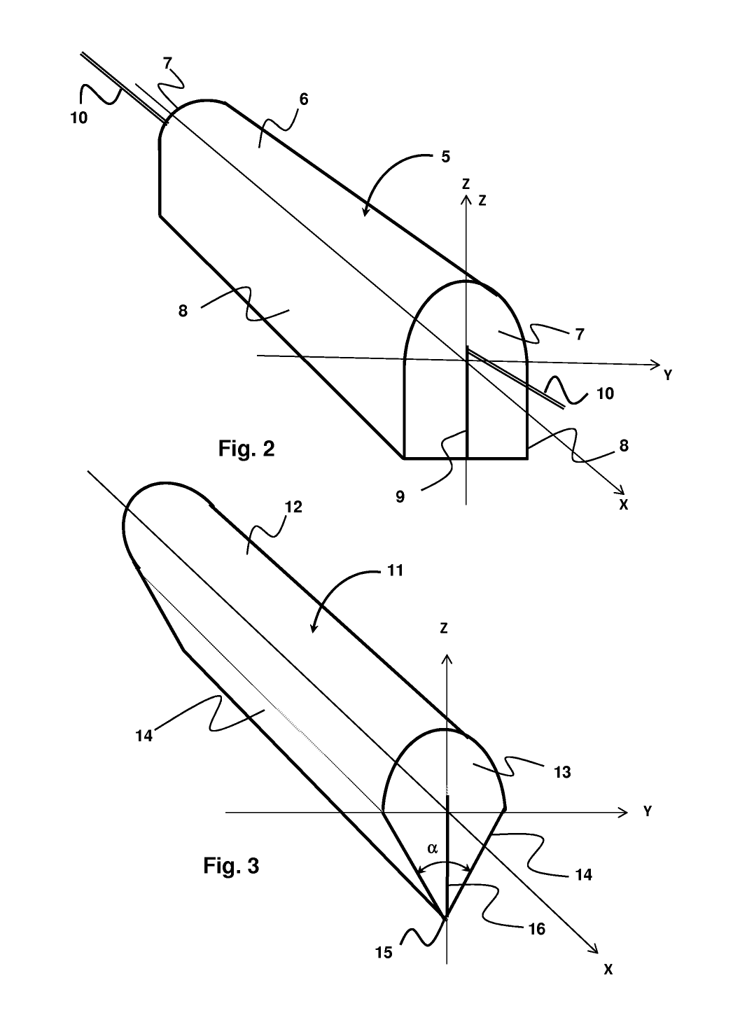

Referring to FIG. 2 there is shown a second embodiment of the laundry drying device according to an aspect of the present disclosure. This embodiment comprises a body 5, extending longitudinally in the x-direction in FIG. 2, which body 5 is provided with a curved upper surface 6 and planar side surfaces 8, extending substantially in the z-direction. The body further comprises substantially planar end surfaces 7 and a substantially planar bottom surface 27. From the bottom surface 27 and towards the xy-plane of the figure there extends a longitudinal slit 9. The length of the slit 9 may correspond to the extension in the z-direction of the side surfaces 8, or the slit 9 may be longer, as shown in FIG. 2, i.e. extending into the curved upper portion of the body, or shorter.

Referring to FIG. 3 there is shown a third embodiment of the present disclosure that may be regarded as a variation of the embodiment shown in FIG. 2. The third embodiment differs from the second embodiment in that the side surfaces 14 do not rum parallel to the xz-plane as in FIG. 2, but forms an angle a with each other as shown in FIG. 3. By this inclined arrangement of the side surfaces 14 it is achieved that a fabric only makes contact with the portion of the device that actually supports it, which may improve drying capacity in the area around the device. Also this device is provided with a slit 16 that extends from the contact edge 15 between the two inclined side surfaces 14 and into the interior of the body 11 of the device.

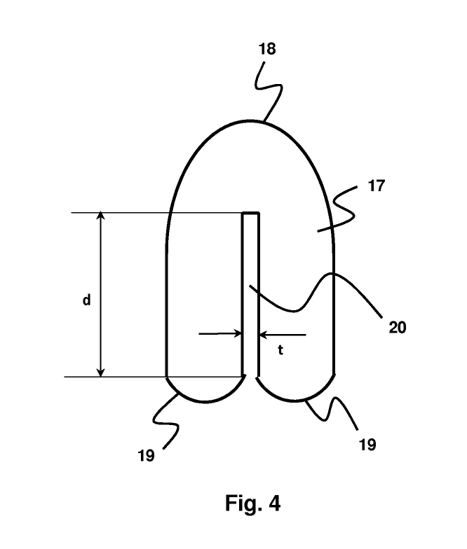

Referring to FIG. 4 there is shown a schematic cross sectional view through a fourth embodiment of the present disclosure, which embodiment comprises rounded bottom portions 19 on either lateral sides of a slit 20 that in the shown embodiment has a finite thickness t, which for instance corresponds to an average thickness of a clothes line. The rounded bottom portions 19 facilitate insertion of a clothes line in the slit 20. It is understood that the rounded bottom portions 19 and the slit 20 of a thickness that is greater than substantially equal to zero can be used together with all other embodiments of the present disclosure, for instance those example embodiments that are shown and described in this specification.

Referring to FIG. 5 there is shown a fifth embodiment of the laundry drying device according to the present disclosure. Whereas embodiments shown in FIGS. 1 through 3 were configured primarily for attachment to a clothes line, the embodiment shown in FIG. 5 is configured for application in connection with a drying rack 26 provided with bars 25 upon which to hang clothes for drying.

The fifth embodiment of the present disclosure shown in FIG. 5 comprises a body with an upper curved surface 21 and substantially planar side surfaces 24 running parallel to each other in the same manner as described in connection with the embodiment shown in FIG. 2. However, instead of being provided with only a single slit, the fourth embodiment is provided with a pair of slits 23′ and 23″ running parallel to each other in the longitudinal direction of the body and in a distance from each other that substantially corresponds to the distance between adjacent bars 25 on the drying rack 26. It is noted that although the fourth embodiment of the present disclosure is shown with two slits 23′ and 23″, other numbers of slits might also be used. Furthermore, although the general configuration of the body of the fourth embodiment corresponds to that of the second embodiment shown in FIG. 2, it is understood that the general shape of the fourth embodiment is not limited to that of the second embodiment. Thus, for instance, the body shapes of the first and third embodiments may also be used instead, but provided with more than one slit as in the fourth embodiment.

With reference to FIGS. 6a to 6e there are shown non-limiting examples of the cross sectional shape of the laundry device according to different embodiments of the present disclosure. Thus, FIG. 6a shows a circular cross sectional shape of the device corresponding to the embodiment shown in FIG. 1 described above. The body 2 of the device has a circular end surface 3 and the device is provided with a vertically (as seen in the figure) slit 4 of very limited thickness, although a slit of a larger thickness, for instance corresponding to that of the embodiment shown in FIG. 4, could alternatively be used.

With reference to FIG. 6b there is shown an embodiment of the device having a vertically (as seen in the figure) elongated cross sectional shape, for instance substantially an ellipsoidal shape. The body 2′ comprises an end surface 3′ and a vertically extending slit 4′.

The embodiments of the present disclosure, the cross sectional shape of which are described in FIGS. 6c through 6e corresponds to those shown in FIGS. 2, 5 and 4, respectively.

Although the dimensions of the drying devices according to the aspects of the present disclosure may vary within wide limits according to the specific application, typical dimensions of the second and third embodiments shown in FIGS. 2 and 3 are 3 cm wide (in the y-direction), 4 cm high (in the z-direction) and 50 to 100 cm long (in the x-direction). A typical length (in the z-direction) of the slit 6 is 28 mm.

The thickness of the slit is very small in the embodiments of the present disclosure described above except for embodiment four shown in FIG. 4. However, according to the aspects of the present disclosure a broader slit may be used, for instance corresponding to the diameter of a clothes line. Such a broader slit may be provided with suitable locking means that ensures that adjacent surfaces of the slit are held together when the device is placed on for instance a clothes line, in order to prevent the device from rotating about the clothes line. For this purpose for instance Velcro strips or an adhesive may be used. Also double-adhesive tape may be used in case the device is to remain permanently on the clothes line.

Although the present disclosure has been described in detail above with reference to specific embodiment hereof it is understood that other shapes of the body of the laundry drying device according to the aspects of the present disclosure could also be envisaged and such embodiments would also fall within the scope of the present disclosure as defined by the patent claims.

What is claimed is:

1. A laundry drying device for clothes lines, laundry racks and the like, comprising an elongated body extending in a longitudinal direction defined by a longitudinal axis X, where said body is configured such that it can surround a clothes line or a bar or line of a drying rack, where said body is a unitary body and where said body is provided with at least one longitudinally extending slit extending from a surface portion of the body and a distance (d) into the body, the slit having a thickness (t), which at least one slit is configured to allow a clothes line or bar to be received in the slit, whereby the device can be hung on the clothes line or bar.

2. A laundry drying device according to claim 1, wherein said body comprises a top surface, side surfaces, end surfaces and bottom surface, wherein said slit extends from the bottom surface and a distance (d) into the interior of the body.

3. A laundry drying device according to claim 1, wherein said body is resilient.

4. A laundry drying device according to claim 3, wherein said body is made from a foam material.

5. A laundry drying device according to claim 3, wherein said body is made of rubber.

6. A laundry drying device according to claim 1, wherein said body is cylindrical.

7. A laundry drying device according to claim 3, wherein said thickness (t) is substantially equal to zero, such that a clothes line or bar can only be inserted into the slit due to the resiliency of the material of the body.

8. A laundry drying device according to claim 1, wherein said thickness (t) is in the range 0 cm to T cm, where T is substantially equal to the thickness or diameter of a typical clothes line or bar in a drying rack.

9. A laundry drying device according to claim 2, wherein said bottom surface comprises rounded portions extending longitudinally on either side of said slit.

10. A laundry drying device according to claim 2, wherein said side surfaces form an angle a between each other.

11. A laundry drying device according to claim 10, wherein said slit extends from the edge portion where the side surfaces meet and into the body of the device.

12. A laundry drying device for clothes lines, laundry racks and the like comprising an elongated body extending in a longitudinal direction defined by a longitudinal axis X, where said body is configured such that it can be supported by two or more clothes lines or bars in a laundry rack, where said body is a unitary body and where said body is provided with at least two longitudinally extending radial slits extending a distance into the body, which at least two slits is configured to allow said clothes lines or laundry rack bars to be received in the slits, whereby said laundry drying device becomes releasably fixed to two or more clothes lines or two or more bars of a laundry rack.

13. A laundry drying device according to claim 12, wherein said body comprises an upper surface, side surfaces, a bottom surface and end surfaces, where the upper surface is upwardly curved away from the bottom surface and wherein the bottom surface is provided with at least two slits extending from the bottom surface into the interior of the body and where the distance between adjacent slits is configured to correspond substantially to the distance between bars of a laundry rack.
